(19) United States
(12) Patent Application Publication
(10) Pub. No.: US 2005/0248528 A1
(43) Pub. Date: Nov. 10, 2005

(54) Time management in presentation device

(75) Inventors: Yves Karcher, Cully (CH); Pascal Eichenberger, Lausanne (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur Morges (CH)

(21) Appl. No.: 10/997,158

(22) Filed: Nov. 24, 2004

(30) Foreign Application Priority Data
May 4, 2004 (FR) 0404776

(51) Int. Cl. G09G 5/00

(52) U.S. Cl. 345/156

(57) ABSTRACT

Embodiments of the present invention provide a presentation device that is simple to control for managing time and providing presentation instruction to a host device to make a presentation. In one embodiment, a presentation device is controlled by a user for providing presentation instruction to a host device to make a presentation. The presentation device comprises a timer button configured to be activated by a user to select an end time for a presentation, wherein each time the timer button is activated, a time interval between a current time and the end time is increased by a preset time increment. A timer module is configured to determine the time interval between the current time and the end time for the presentation as time passes; and a display configured to display the time interval between the current time and the end time for the presentation as time passes.

### CROSS-REFERENCES TO RELATED APPLICATIONS

This application claims priority from French Patent Application No. 0404776, filed May 4, 2004, the entire disclosure of which is incorporated herein by reference.

### BACKGROUND OF THE INVENTION

This invention relates generally to input devices and, more particularly to a presentation device having time management features.

Presentation devices allow a user to control a host device such as a computer or a projector to make a presentation utilizing software such as PowerPoint™ or the like. A presentation typically has a defined time limit. It is desirable to provide time managing features in the presentation device.

### BRIEF SUMMARY OF THE INVENTION

Embodiments of the present invention provide a presentation device that is simple to control for managing time and providing presentation instruction to a host device to make a presentation.

An aspect of the present invention is directed to a presentation device controlled by a user for providing presentation instruction to a host device to make a presentation. The presentation device comprises a timer button configured to be activated by a user to select an end time for a presentation, wherein each time the timer button is activated, a time interval between a current time and the end time is increased by a preset time increment. A timer module is configured to determine the time interval between the current time and the end time for the presentation as time passes; and a display configured to display the time interval between the current time and the end time for the presentation as time passes.

In some embodiments, the display is configured to display a countdown of the time interval to the end time to show time remaining for the presentation A remaining time alert module is configured to alert the user of a preset remaining time to the end time. The remaining time alert module may be configured to alert the user of a first preset remaining time to the end time and a second preset remaining time to the end time, wherein the first preset remaining time is different from the second preset remaining time. A vibration member is configured to produce a vibration at at least one of the end time and the preset remaining time to the end time. A next button is pressed to advance to a next presentation display. A previous button is pressed to retreat to a previous presentation display. A blank button is pressed to provide a blank display. A reset button is pressed to reset the timer module. A current time button is pressed to display a current time of an internal clock. A battery alert unit is configured to provide notification when a battery level of a battery in the presentation device falls below a preset level. A wireless communication unit is configured to provide wireless communication with a host device to make a presentation.

Another aspect of the invention is directed to a presentation device controlled by a user for providing presentation instruction to a host device to make a presentation. The presentation device comprises a timer button configured to be activated by a user to select an end time for a presentation, wherein each time the timer button is activated, a time interval between a current time and the end time is increased by a preset time increment. A timer module is configured to determine the time interval between the current time and the end time for the presentation as time passes. A remaining time alert module is configured to alert the user of a preset remaining time to the end time.

Another aspect of this invention is directed to a method of managing time for a presentation device used for providing instruction to a host device to make a presentation. The method comprises setting, at an initial current time, an initial time interval between the initial current time and an end time for a presentation in response to activation of a timer button; determining the time interval between a current time and the end time for the presentation as time passes; and displaying the time interval between the current time and the end time for the presentation as time passes. Each time the time button is activated, the time interval between the current time and the end time is increased by a preset time increment.

In some embodiments, displaying the time interval comprises displaying a countdown of the time interval to the end time to show time remaining for the presentation. The method may further comprise wirelessly providing instruction from the presentation device to a host device to make a presentation. The method may include providing instruction from the presentation device to a host device to make a presentation. The instruction includes at least one of advancing to a next presentation display, retreating to a previous presentation display, and providing a blank display. The method may further comprise resetting the time interval between the current time and the end time for the presentation in response to activation of a reset button.

### BRIEF DESCRIPTION OF THE DRAWINGS

FIG. 1 is a functional block diagram of a presentation device according to an embodiment of the present invention.

FIG. 2 is a schematic diagram illustrating external features of a presentation device according to an embodiment of the present invention.

FIG. 3 is a front elevational view of a presentation device according to another embodiment of the present invention.

FIG. 4 is a side elevational view of the presentation device of FIG. 3.

FIG. 5 is a top plan view of the presentation device of FIG. 3.

FIG. 6 is a bottom plan view of the presentation device of FIG. 3.

### DETAILED DESCRIPTION OF THE INVENTION

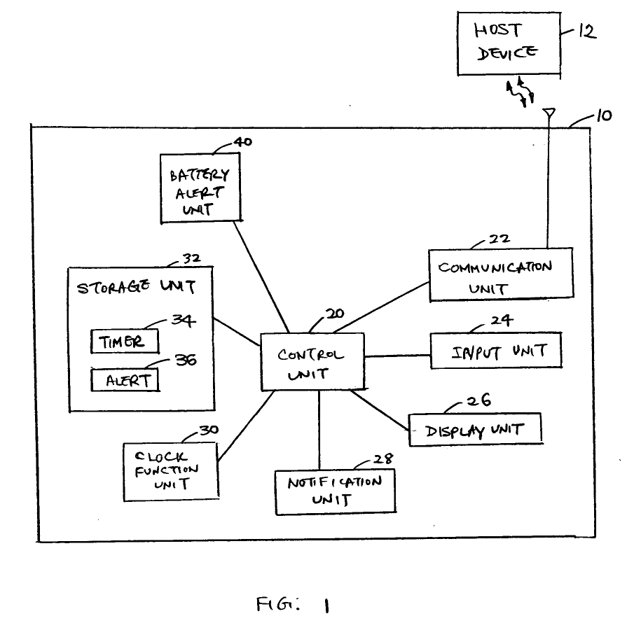

FIG. 1 shows a presentation device 10 which is controlled by a user for providing presentation instructions to a host device 12 to make a presentation. The host device 12 may be a computer having presentation software such as PowerPoint™ or the like. The presentation device 10 is typically a handheld remote device that communicates wirelessly with the host device 12, although a wired connection between the presentation device 10 and the host device 12 is possible in other embodiments.

The presentation device 10 includes a control unit 20, a communication unit 22, an input unit 24, a display unit 26, a notification unit 28, a clock function unit 30, and a storage unit 32. The communication unit 22 is controlled by the control unit 20 to perform wireless communication with the host device 12. The input unit 24 includes any suitable mechanisms for providing input including, for example, buttons, switches, or the like. The display unit 26 may be a liquid crystal display (LCD), a light emitting diode (LED), or the like. The display unit 26 is controlled by the control unit 20 to display alphanumerical information, image information, or the like. The notification unit 28 is a speaker, for example, and is controlled by the control unit 20 to alert the user by sound or movement such as vibration. The clock function unit 30 is capable of referencing current time information from the control unit 20, and acts as an internal clock. The storage unit 32 is a memory such as RAM, and is capable of storing various information to be processed by the control unit 20. The storage unit 32 may store software modules that are executable by the control unit 20 to perform specified functions. For example, a timer module 34 is controlled by the control unit 20 to time a presentation. An alert module 36 is controlled by the control unit 20 to alert the user when the time remaining in the presentation reaches a preset remaining time. A battery alert unit 40 may be provided to notify the user when the battery level of a battery in the presentation device 10 falls below a preset level. The battery alert unit 40 may activate the notification unit 28 or utilize the display unit 26 to notify the user of a low battery situation.

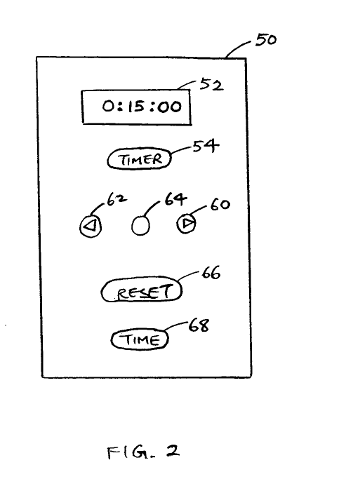

FIG. 2 shows an arrangement of input and display features of the presentation device 10. The housing 50 has a display 52 and a plurality of buttons. A timer button 54 can be activated by a user to set the duration for a presentation. Each time the timer button 54 is pressed, a time interval between a current time and an end time is increased by a preset time increment. For example, the preset time increment is 15 minutes. If the user presses the timer button 54 once, the time interval is 15 minutes; if the user presses the timer button 54 four times, the time interval is 60 minutes. During initial setup, the user can press the timer button 54 to set an initial time interval for the presentation from the initial current time to the end time. In response to the activation of the timer button 54 and elapse of time (e.g., by referencing the clock function unit 30), the timer module 34 in FIG. 1 determines the time interval or duration between the current time and the end time for the presentation as time passes. The display 52 displays the timer interval between the current time and the end time for the presentation as time passes. The display 52 may display a countdown of the time interval to the end time to show time remaining for the presentation.

As shown in FIG. 2, the presentation device 10 includes other buttons on the housing 50. These buttons are for illustrative purposes, and may be replaced by other buttons in other embodiments. A number of buttons are used to provide instruction to the host device 12. FIG. 2 shows a “next” button 60, a “previous” button 62, and a “blank” button 64. The next button 60 is pressed to advance to a next presentation display. The previous button 62 is pressed to retreat to a previous presentation display. The blank button 64 is pressed to provide a blank display. In some cases, the blank button 64 has a toggle feature and pressing the blank button 64 while the display is blank returns the display to the original display before the blank button 64 was initially pressed. A reset button 66 is pressed to reset the timer module 34 of FIG. 1, so that the user may use the timer button 54 to set another presentation time. A time button 68 is pressed to show a current time, for instance, by accessing the clock function unit 30 of FIG. 1.

The presentation device 10 may notify the user when the time remaining in a presentation reaches a certain level. The alert module 36 of FIG. 1 is controlled by the control unit 20 to alert the user of a preset remaining time to the end time. For example, the user is notified when the remaining time reaches 10 minutes. In some cases, the user is notified when the remaining time reaches a first preset remaining time (e.g., 10 minutes), and then again when the remaining time reaches a second preset remaining time (e.g., 5 minutes). The user may be notified at the end time when the remaining time is zero. Typically, the preset remaining time is shorter than the preset time increment when the timer button 54 is pressed to set the presentation time. The control unit 20 may utilize the notification unit 28 to alert the user by producing a vibration or the like.

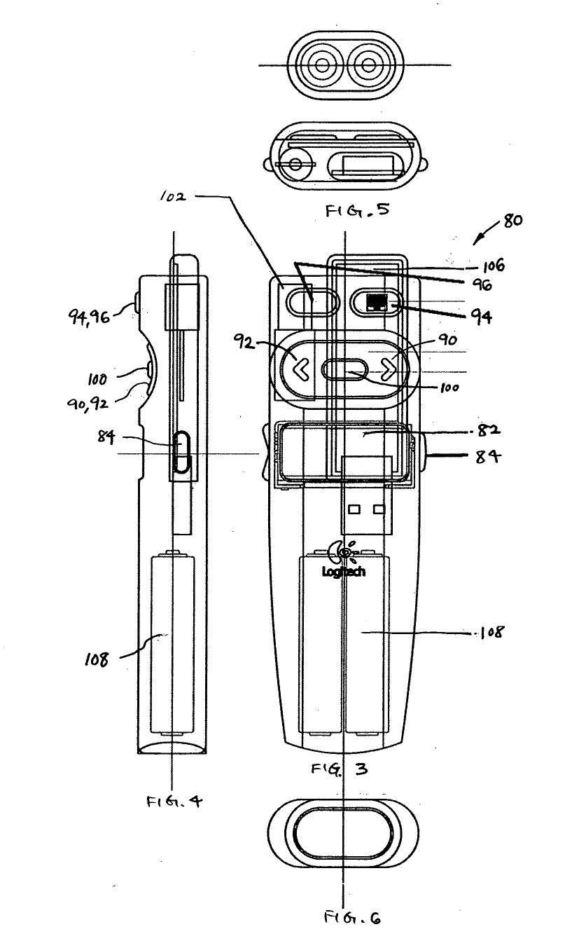

FIGS. 3-6 show another embodiment of a presentation device 80 having a display 82 and a plurality of buttons. A timer or “stop watch” button 84 can be activated by a user to set the duration for a presentation. Each time the timer button 84 is pressed, a time interval between a current time and an end time is increased by a preset time increment. The display 82 displays the timer interval between the current time and the end time for the presentation as time passes. Additional buttons include a “next” or “forward” button 90, a “previous” or “backward” button 92, and a “blank” button 94. The forward button 90 is pressed to advance to a next presentation display. The previous button 92 is pressed to retreat to a previous presentation display. The blank button 94 is pressed to provide a blank display. A start/stop button 96 is used to start/stop a slide show such as that available for PowerPoint™. A laser control button 100 is provided to turn on and off the laser pointer 102. The presentation device 80 further includes a wireless receiver 106 and a compartment for a battery 108.

The above-described arrangements of apparatus and methods are merely illustrative of applications of the principles of this invention and many other embodiments and modifications may be made without departing from the spirit and scope of the invention as defined in the claims. For example, the timer module 34 and the alert module 36 may be implemented in other ways than that shown in FIG. 1, using different hardware, firmware, or software. The scope of the invention should, therefore, be determined not with reference to the above description, but instead should be determined with reference to the appended claims along with their full scope of equivalents.

1. A presentation device controlled by a user for providing presentation instruction to a host device to make a presentation, the presentation device comprising:
a timer button configured to be activated by a user to select an end time for a presentation, wherein each time the timer button is activated, a time interval between a current time and the end time is increased by a preset time increment;
a timer module configured to determine the time interval between the current time and the end time for the presentation as time passes; and
a display configured to display the time interval between the current time and the end time for the presentation as time passes.

2. The presentation device of claim 1 wherein the display is configured to display a countdown of the time interval to the end time to show time remaining for the presentation.

3. The presentation device of claim 1 further comprising a remaining time alert module configured to alert the user of a preset remaining time to the end time.

4. The presentation device of claim 3 wherein the remaining time alert module is configured to alert the user of a first preset remaining time to the end time and a second preset remaining time to the end time, the first preset remaining time being different from the second preset remaining time.

5. The presentation device of claim 3 further comprising a vibration member configured to produce a vibration at at least one of the end time and the preset remaining time to the end time.

6. The presentation device of claim 1 further comprising at least one of a next button to advance to a next presentation display, a previous button to retreat to a previous presentation display, a blank button to provide a blank display, a reset button to reset the timer module, a laser control button to control a laser pointer, a start/stop button to start/stop a slide show presentation, and a current time button to display a current time of an internal clock.

7. The presentation device of claim 1 further comprising a battery alert unit configured to provide notification when a battery level of a battery in the presentation device falls below a preset level.

8. The presentation device of claim 1 further comprising a wireless communication unit configured to provide wireless communication with a host device to make a presentation.

9. A presentation device controlled by a user for providing presentation instruction to a host device to make a presentation, the presentation device comprising:
a timer button configured to be activated by a user to select an end time for a presentation, wherein each time the timer button is activated, a time interval between a current time and the end time is increased by a preset time increment;
a timer module configured to determine the time interval between the current time and the end time for the presentation as time passes; and
a remaining time alert module configured to alert the user of a preset remaining time to the end time.

10. The presentation device of claim 9 wherein the preset remaining time to the end time is shorter than the preset time increment.

11. The presentation device of claim 10 wherein the remaining time alert module is configured to alert the user of a first preset remaining time to the end time and a second preset remaining time to the end time, the first preset remaining time being different from the second preset remaining time.

12. The presentation device of claim 10 further comprising a vibration member configured to produce a vibration at at least one of the end time and the preset remaining time to the end time.

13. A method of managing time for a presentation device used for providing instruction to a host device to make a presentation, the method comprising:
setting, at an initial current time, an initial time interval between the initial current time and an end time for a presentation in response to activation of a timer button;
determining the time interval between a current time and the end time for the presentation as time passes; and
displaying the time interval between the current time and the end time for the presentation as time passes,
wherein each time the time button is activated, the time interval between the current time and the end time is increased by a preset time increment.

14. The method of claim 13 wherein displaying the time interval comprises displaying a countdown of the time interval to the end time to show time remaining for the presentation.

15. The method of claim 13 further comprising providing a notification at a preset remaining time to the end time.

16. The method of claim 15 wherein providing the notification comprises providing a first notification at a first preset remaining time to the end time and providing a second notification at a second preset remaining time to the end time, the first preset remaining time being different from the second preset remaining time.

17. The method of claim 15 wherein providing the notification comprises producing a vibration.

18. The method of claim 13 further comprising wirelessly providing instruction from the presentation device to a host device to make a presentation.

19. The method of claim 13 further comprising providing instruction from the presentation device to a host device to make a presentation, the instruction including at least one of advancing to a next presentation display, retreating to a previous presentation display, and providing a blank display.

20. The method of claim 13 further comprising resetting the time interval between the current time and the end time for the presentation in response to activation of a reset button.
